(19) United States
(12) Patent Application Publication
(10) Pub. No.: US 2025/0168287 A1
(43) Pub. Date: May 22, 2025

(54) IMAGE READING DEVICE

(71) Applicant: SEIKO EPSON CORPORATION, Tokyo (JP)

(72) Inventors: Nobutaka UEMURA, KITAKYUSHU-SHI (JP); Sekito MASARU, KITAKYUSHU-SHI (JP)

(21) Appl. No.: 18/953,988

(22) Filed: Nov. 20, 2024

(30) Foreign Application Priority Data
Nov. 21, 2023 (JP) 2023-197184
Dec. 22, 2023 (JP) 2023-216598

(51) Int. Cl. H04N 1/024; B41J 3/44

(52) U.S. Cl. CPC H04N 1/02409; B41J 3/44; H04N 2201/0094

(57) ABSTRACT

An image reading device includes a transport unit that transports a medium along a transport path, a sensor unit that is disposed on the transport path and reads an image of the transported medium, and a pressing unit that presses the sensor unit toward the transport path facing the sensor unit. The sensor unit includes a lens array having an elongated shape, a base frame that supports the lens array, and a cover portion that engages with the base frame and covers the lens array. The pressing unit abuts against the cover portion and presses the cover portion toward the transport path, from an abutting portion of the pressing unit that abuts against the cover portion. The base frame and the cover portion are separated from each other in a pressing direction in which the pressing unit presses the cover portion.

The present application is based on, and claims priority from JP Application Serial Number 2023-197184, filed Nov. 21, 2023, and 2023-216598, filed Dec. 22, 2023, the disclosures of which are hereby incorporated by reference herein in their entirety.

### BACKGROUND

### 1. Technical Field

The present disclosure relates to an image reading device.

### 2. Related Art

In related art, as disclosed in JP-A-2013-168925, an image recording device is known in which, in order to inhibit a frame of an image sensor unit having an elongated shape from sagging under its own weight, and to inhibit deviation of a focal point of a lens array on a medium, a rigid material such as aluminum is used for the frame.

However, for example, in the configuration disclosed in JP-A-2013-168925 in which the image sensor unit of the image recording device is pressed, there is a possibility that the lens array is bent by the pressing and the lens array cannot be located at an appropriate position.

### SUMMARY

An image reading device includes a transport unit configured to transport a medium along a transport path, a sensor unit disposed on the transport path and configured to read an image of the transported medium, and a pressing unit configured to press the sensor unit toward the transport path facing the sensor unit. The sensor unit includes a lens array having an elongated shape, a base frame configured to support the lens array, and a cover portion configured to engage with the base frame and cover the lens array. The pressing unit abuts against the cover portion and presses the cover portion toward the transport path from an abutting portion of the pressing unit abutting the cover portion. The base frame and the cover portion are separated from each other in a pressing direction in which the pressing unit presses the cover portion.

An image reading device includes a placement unit being light-transmissive and on which a medium is placeable, a reading unit configured to read, through the placement unit, an image of the medium placed on the placement unit, a carriage configured to support the reading unit to be movable along a movement axis, a rail disposed along the movement axis and configured to support the carriage, and a pressing support portion disposed between the reading unit and the carriage and configured to press the reading unit toward the placement portion. The reading unit includes a lens array having an elongated shape, a base frame configured to support the lens array, and a cover portion configured to cover the base frame. The pressing support portion is in contact with the cover portion and presses the cover portion in a pressing application direction toward the placement unit from a contact portion of the pressing support portion in contact with the cover portion. The base frame and the cover portion are separated from each other in the pressing application direction.

### BRIEF DESCRIPTION OF THE DRAWINGS

FIG. 1 is a perspective view of a multifunction peripheral.

FIG. 2 is a cross-sectional view mainly illustrating an image reading device as viewed from an X direction.

FIG. 3 is a perspective view mainly illustrating a sensor unit included in the image reading device.

FIG. 4 is a perspective view illustrating the sensor unit with a cover thereof removed.

FIG. 5 is a perspective view mainly illustrating the front of the sensor unit.

FIG. 6 is a cross-sectional view mainly illustrating the sensor unit as viewed from a Y direction.

FIG. 7 is a perspective view of a cross section taken along the line I-I in FIG. 6.

FIG. 8 is a cross-sectional view illustrating bending of a CISM and a lens array as viewed from the Y direction.

FIG. 9 is a view illustrating a schematic configuration of a lower unit.

FIG. 10 is a view illustrating a cross-sectional configuration of the lower unit.

FIG. 11 is a view illustrating a configuration of a second sensor unit and a carriage.

FIG. 12 is a view illustrating a schematic configuration of the second sensor unit.

FIG. 13 is a view illustrating a cross-sectional configuration of the second sensor unit.

FIG. 14 is an enlarged view of a part of the second sensor unit.

FIG. 15 is an enlarged view of a part of the second sensor unit.

FIG. 16 illustrates a schematic configuration of the second sensor unit.

FIG. 17 is an enlarged view of a part of the second sensor unit.

FIG. 18 is a view schematically illustrating a support configuration of the second sensor unit.

FIG. 19 is a cross-sectional view illustrating bending of the CISM and the lens array as viewed from a−Y direction.

FIG. 20 is a view illustrating a schematic configuration of a pressing member.

FIG. 21 is an enlarged view illustrating a part of the second sensor unit.

FIG. 22 is a view illustrating a schematic configuration of a positioning member.

FIG. 23 is a view illustrating a cross-sectional configuration of the second sensor unit.

### DESCRIPTION OF EMBODIMENTS

A configuration of an image reading device 2 will be described below. Note that, in this embodiment, a configuration of a multifunction peripheral 1 including the image reading device 2 will be described as an example, with reference to the drawings. Note that directions in the drawings will be described using a three-dimensional coordinate system. For convenience of description, a+direction of a Z-axis will be referred to as an upward direction, upward, or simply up, a−direction of the Z-axis will be referred to as a downward direction, downward, or simply down, a+direction of an X-axis will be referred to as a rearward direction, rearward, or simply rear, a−direction of the X-axis will be referred to as a forward direction, forward, or simply front, a+direction of a Y-axis will be referred to as a leftward direction, leftward, or simply left, and a−direction of the Y-axis will be referred to as a rightward direction, rightward, or simply right.

Note that the image reading device 2 can be used in a stand alone manner, rather than as part of the multifunction peripheral 1.

### 1. Configuration of Image Reading Device

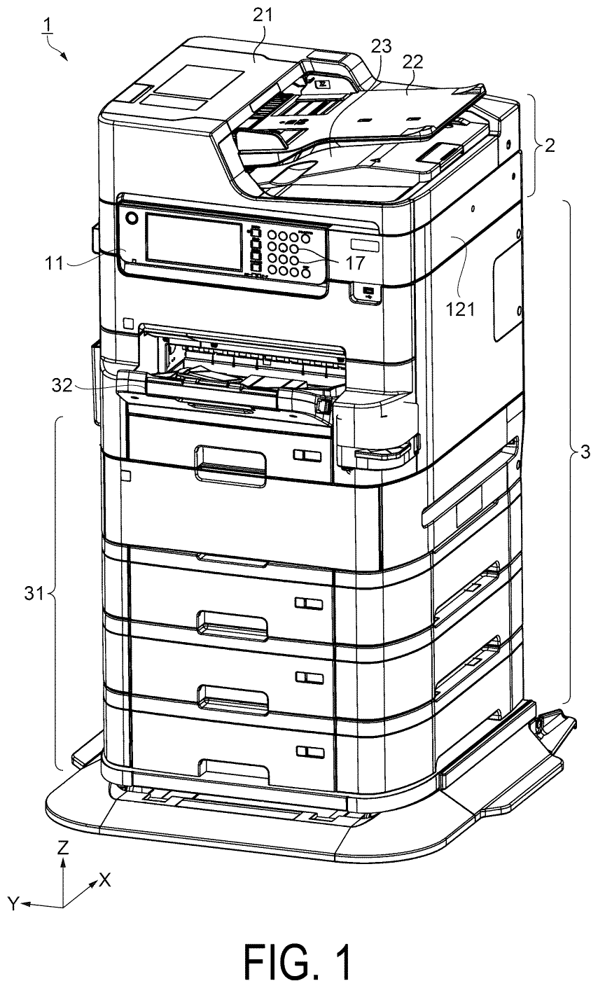

As illustrated in FIG. 1, the multifunction peripheral 1 includes the image reading device 2 disposed in an upper portion of the multifunction peripheral 1, and an image recording device 3 disposed in a lower portion of the multifunction peripheral 1. The multifunction peripheral 1 is also referred to as an image forming device.

The multifunction peripheral 1 includes an input/output unit 11. The input/output unit 11 outputs menus of the image reading device 2 and the image recording device 3, and inputs user operations related to the image reading device 2 and the image recording device 3. The input/output unit 11 includes, for example, a touch panel display, buttons, and the like.

The image recording device 3 includes a medium storage unit 31 in which a medium M is stored, an image recording unit (not illustrated) that transports the medium M from the medium storage unit 31 and records an image on the medium M using an inkjet head or the like, and a recording medium discharge unit 32 that discharges the medium M on which the image is recorded.

As illustrated in FIG. 1, the image reading device 2 includes a medium placement unit 22, a medium discharge unit 23, an upper unit 21 on which the medium placement unit 22 and the medium discharge unit 23 are mounted, and a lower unit 121 disposed below the upper unit 21. The upper unit 21 can be opened and closed with respect to a document table 27, which will be described later.

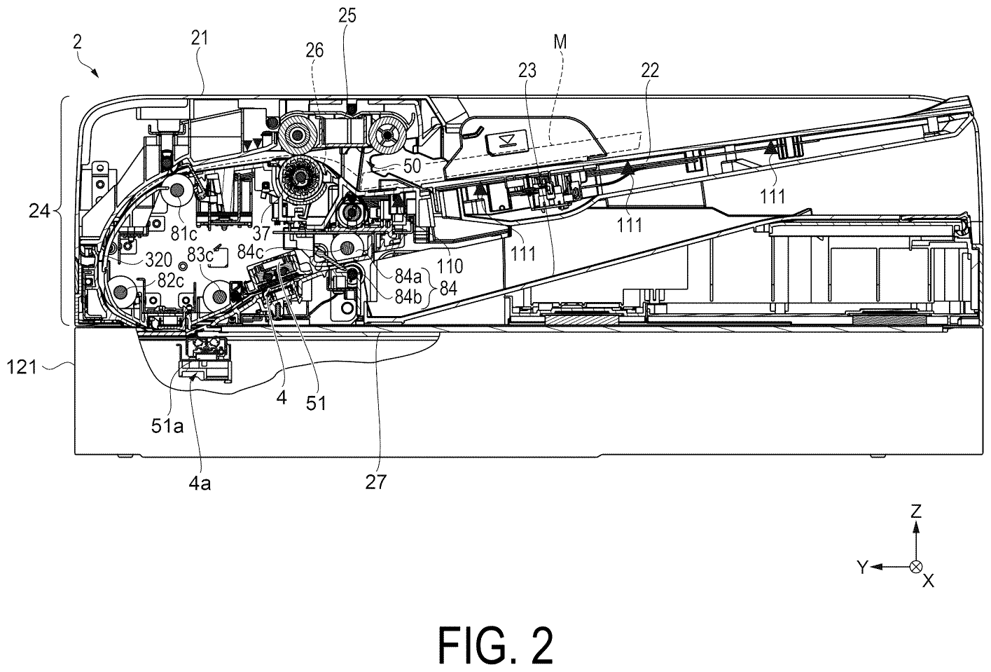

As illustrated in FIG. 2, the upper unit 21 of the image reading device 2 further includes a transport unit 24 including a transport path 26 of the medium M indicated by a broken line and a feeding unit 25, a first sensor unit 4, and a first elastic member 51. Note that the medium M to be read by the image reading device 2 is also referred to as a document.

The transport path 26 includes a bent path 320 that is bent and continuously formed from the medium placement unit 22 located on the upper right in FIG. 2, to the medium discharge unit 23 located on the lower right in FIG. 2. Hereinafter, in a transport direction of the medium M on the transport path 26, the medium placement unit 22 side is referred to as upstream, and the medium discharge unit 23 side is referred to as downstream.

A placement detector 110 detects the medium M placed on the medium placement unit 22. A size detector 111 detects the size of the medium M placed on the medium placement unit 22. A regulating unit 50 regulates feeding, in the transport direction, of the medium M placed on the medium placement unit 22.

The feeding unit 25 includes a retard roller 37 and the like. The feeding unit 25 can separate and feed the media M one by one from a plurality of the media M stacked on the medium placement unit 22.

The transport unit 24 includes a plurality of rollers such as rollers 81c, 82c, 83c, and 84c disposed inside the transport path 26, and rollers 84a and 84b constituting a roller pair 84. The transport unit 24 transports the medium M fed from the feeding unit 25 in the transport direction along the transport path 26.

On the transport path 26, the second sensor unit 4a is disposed upstream, and the first sensor unit 4 is disposed downstream.

The first sensor unit 4 reads, from above, an image on a first surface of the medium M transported on the transport path 26. The first elastic member 51, which is a pressing unit, presses the first sensor unit 4 toward the transport path 26 facing the first sensor unit 4. Hereinafter, pressing will be also referred to as pushing. That is, the first elastic member 51 acts so as to push the first sensor unit 4 toward the transport path 26 side, and can hold the first sensor unit 4 at a predetermined position.

As a result, the distance between the first sensor unit 4 and the medium M transported on the transport path 26 can be set to a predetermined distance by the first elastic member 51. In addition, by the first elastic member 51, it is possible to appropriately position the first sensor unit 4, a CISM 40 mounted on the first sensor unit 4, and a lens array 43 mounted on the CISM 40. The CISM 40 and the lens array 43 will be described later.

A second surface, which is the opposite surface of the first surface of the medium M, is guided by the document table 27 from below, at a position upstream of the first sensor unit 4 on the transport path 26. The document table 27 is formed, for example, of glass that can transmit light. The first sensor unit 4 corresponds to an example of a sensor unit.

The second sensor unit 4a can read, through the document table 27, an image on the second surface of the medium M transported on the transport path 26, from below. Similarly to the first sensor unit 4, the second sensor unit 4a includes the CISM 40 on which the lens array 43 is mounted. The CISM 40 mounted on the second sensor unit 4a has the same configuration as that of the CISM 40 mounted on the first sensor unit 4. A second elastic member 51a acts to push the second sensor unit 4a toward the document table 27. As in the case of the first sensor unit 4 described above, by the second elastic member 51a, a predetermined distance can be set between the second sensor unit 4a and the medium M. The second sensor unit 4a and the second elastic member 51a are disposed at the lower unit 121.

Further, the second sensor unit 4a can be moved in the left-right direction along the document table 27 by a moving unit 125, which will be described below. An user opens the upper unit 21 and places the medium M on the document table 27. The upper unit 21 presses the medium M placed on the document table 27 from above. The second sensor unit 4a can also read the placed medium M through the document table 27, while being moved by the moving unit 125. The second sensor unit 4a corresponds to an example of a reading unit.

The second sensor unit 4a and the second elastic member 51a can have the same configurations as those of the first sensor unit 4 and the first elastic member 51 described above, respectively, except that the document table 27 is used instead of a guide 28 described below. The first sensor unit 4 and the first elastic member 51 have the same functions as those of the second sensor unit 4a and the second elastic member 51a, respectively.

### 2. Configuration of First Sensor Unit

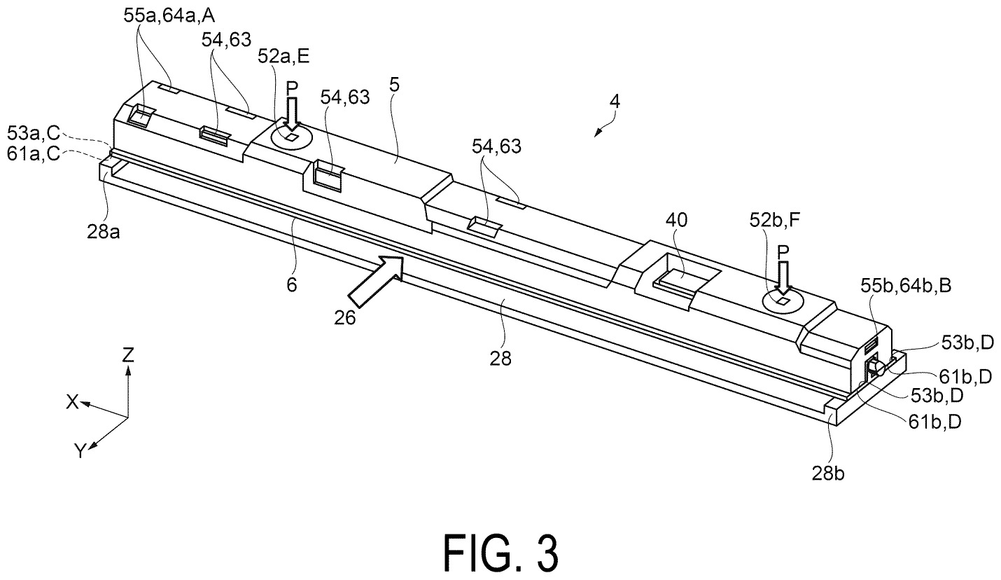

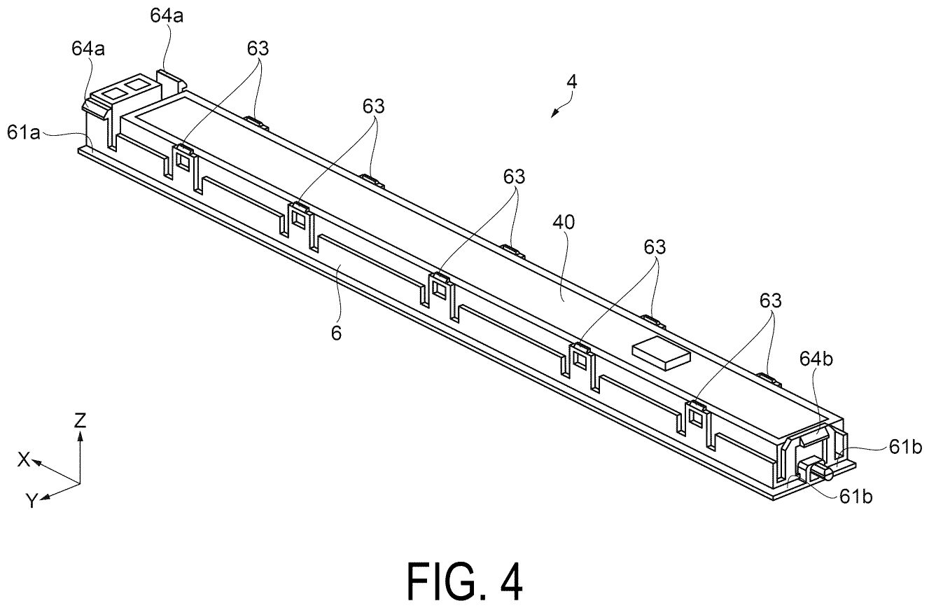

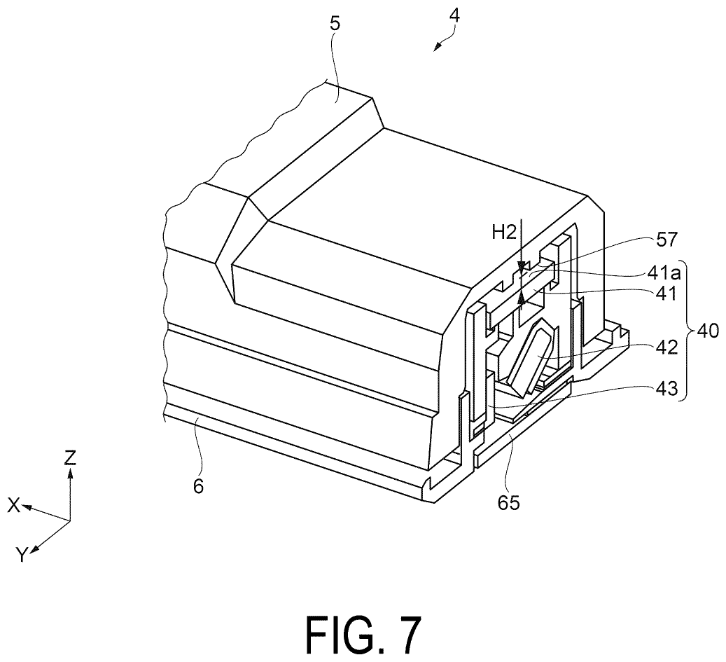

A configuration of the first sensor unit 4 will be described with reference to FIGS. 3 to 8. As illustrated in FIG. 3, the first sensor unit 4 is configured such that the contact image sensor module (CISM) 40 is supported by a frame 6, which is a base frame, and is covered with a cover 5, which is a cover portion. As illustrated in FIG. 4, the CISM 40 is fixed to the frame 6 by a plurality of hooks 63. Note that although the configuration of the CISM 40 will be described later with reference to FIG. 7, the CISM 40 includes a substrate 41, an LED array 42, and the lens array 43. The cover 5 can also cover these components.

The first sensor unit 4, and also the CISM 40, the cover 5, and the frame 6 included in the first sensor unit 4 are each configured to have an elongated shape. Hereinafter, an end at the rear and an end at the front in the front-rear direction, which is an extending direction of these components, are also referred to as a rear end and a front end, respectively.

As illustrated in FIG. 3, a first engaging claw 64a at the rear end and a second engaging claw 64b at the front end of the frame 6 are engaged with a first engaging hole 55a and a second engaging hole 55b of the cover 5, respectively. A combination of the engaging claw and the engaging hole is referred to as a so-called snap-fit. The cover 5 is engaged with the frame 6 from the front and rear ends by the snap-fit. The snap-fit makes it easy to assemble the first sensor unit 4.

The position of the rear end at which the first engaging claw 64a of the frame 6 engages with the first engaging hole 55a of the cover 5 is referred to as a first position A. The position of the front end at which the second engaging claw 64b of the frame 6 engages with the second engaging hole 55b of the cover 5 is referred to as a second position B.

The first position A and the second position B are also positions for positioning the cover 5 with respect to the frame 6. Each of the first position A and the second position B, which are the locations of the snap-fit engagement, is located on the upper side of the end of the cover 5.

By configuring the snap-fit engagement on the upper side of the cover 5, for example, the first engaging claw 64a of the frame 6 at the rear end can be formed longer in the up-down direction, and the first engaging hole 55a of the cover 5 can also be formed longer in the up-down direction. By forming the first engaging claw 64a and the first engaging hole 55a to be long, the strength of engagement can be increased, and breakage can be suppressed.

The same applies to the second engaging claw 64b of the frame 6 and the second engaging hole 55b of the cover 5 at the front end.

There are two of the first elastic members 51 (not illustrated in FIGS. 3 to 7) at the front and at the rear, and each of the first elastic members 51 can press the cover 5 from above with a pressing force P. Note that, in the following description, the two elastic members and the respective pressing forces P will be collectively referred to simply as the first elastic member 51 and the pressing force P unless otherwise specified. The direction in which the pressing force P acts is a pressing direction, and in this example, the pressing direction is downward. That is, the pressing direction is a direction in which the first elastic member 51 presses the cover 5.

The first elastic member 51 is, for example, a compression coil spring. The first elastic member 51 may be another type of spring or rubber. Note that, in FIGS. 3 to 8, for convenience, the configurations of the first sensor unit 4 and the like are illustrated with the pressing direction of the first elastic member 51 being the downward direction along the Z-axis.

A first receiving portion 52a positioned at the rear and a second receiving portion 52b positioned at the front are provided at the upper surface of the cover 5. Each of the first receiving portion 52a and the second receiving portion 52b is recessed in a circular shape so as to receive the first elastic member 51 at a predetermined position. Positions at which the first receiving portion 52a and the second receiving portion 52b receive the pressing force P of the first elastic member 51 are referred to as a fifth position E and a sixth position F, respectively.

The pressing force P of each of the first elastic members 51 applied to the cover 5 from above is transmitted from the first receiving portion 52a, which is the fifth position E, and the second receiving portion 52b, which is the sixth position F, to the first position A and the second position B configured by the above-described snap-fit, at the front and the rear of the cover 5.

On the upper surface of the frame 6, a first frame end 61a is formed at the rear end, and a second frame end 61b is formed at the front end. On the other hand, the cover 5 includes a first cover end 53a extending downward from the rear end, and a second cover end 53b extending downward from the front end.

The first frame end 61a, the second frame end 61b, the first cover end 53a, and the second cover end 53b may be each configured to have, for example, a trapezoidal shape or a protruding shape so that portions in which they abut against each other protrude.

In the cover 5 and the frame 6, the first cover end 53a and the first frame end 61a abut against each other at the rear end, and the second cover end 53b and the second frame end 61b abut against each other at the front end. In the cover 5 and the frame 6, the abutting position at the rear end is referred to as a third position C, and the abutting position at the front end is referred to as a fourth position D. The third position C and the fourth position D are also positions for positioning the cover 5 with respect to the frame 6.

In this way, the frame 6 can fix the cover 5 at the fifth position E and the sixth position F on the upper side and at the third position C and the fourth position D on the lower side.

In the cover 5, the pressing force P of the first elastic member 51 is transmitted from the fifth position E and the sixth position F to the first position A and the second position B, and is then transmitted from the third position C and the fourth position D to the frame 6.

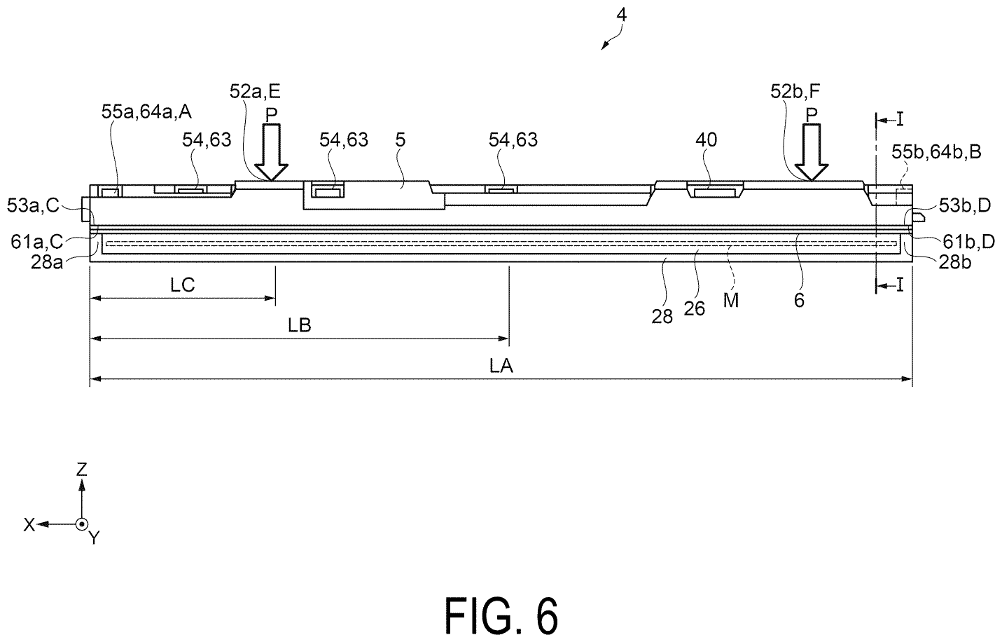

As illustrated in FIGS. 3 and 6, the transport path 26 of the medium M is constituted by the frame 6 provided on the upper side and the guide 28 provided on the lower side. A first guide end 28a and a second guide end 28b extending upward are formed at the front and rear ends of the guide 28. The front-rear direction of the transport path 26, which is the width direction of the medium M, is defined by the first guide end 28a and the second guide end 28b of the guide 28.

Each of the first guide end 28a at the rear end of the guide 28 and the second guide end 28b at the front end of the guide 28 supports the frame 6 from below, and can also receive the pressing force P of the first elastic member 51. Note that, as will be described below, a cover glass 65 is provided on the lower side of the frame 6.

In this way, in the first sensor unit 4, the first position A and the third position C are in a vertical positional relationship at the rear end. In addition, the first guide end 28a is located below the third position C. That is, in the −Z direction, the first position A, the third position C, and the first guide end 28a are located in this order.

On the other hand, in the first sensor unit 4, the second position B and the fourth position D are in a vertical positional relationship at the front end. In addition, the second guide end 28b is located below the fourth position D. That is, in the −Z direction, the second position B, the fourth position D, and the second guide end 28b are located in this order.

At the rear of the first sensor unit 4, the pressing force P of the first elastic member 51 is transmitted from the fifth position E of the cover 5 to the frame 6, via the first position A and the third position C, which are in the vertical positional relationship as described above. Then, the pressing force P is received by the first guide end 28a located below the third position C.

On the other hand, at the front of the first sensor unit 4, the pressing force P of the first elastic member 51 is transmitted from the sixth position F of the cover 5 to the frame 6, via the second position B and the fourth position D, which are in the vertical positional relationship as described above. Then, the pressing force P is received by the second guide end 28b located below the fourth position D.

That is, the two first elastic members 51 abut against the cover 5 and push the cover 5 toward the transport path 26 from the fifth position E and the sixth position F, each of which is an abutting portion that abuts against the cover 5.

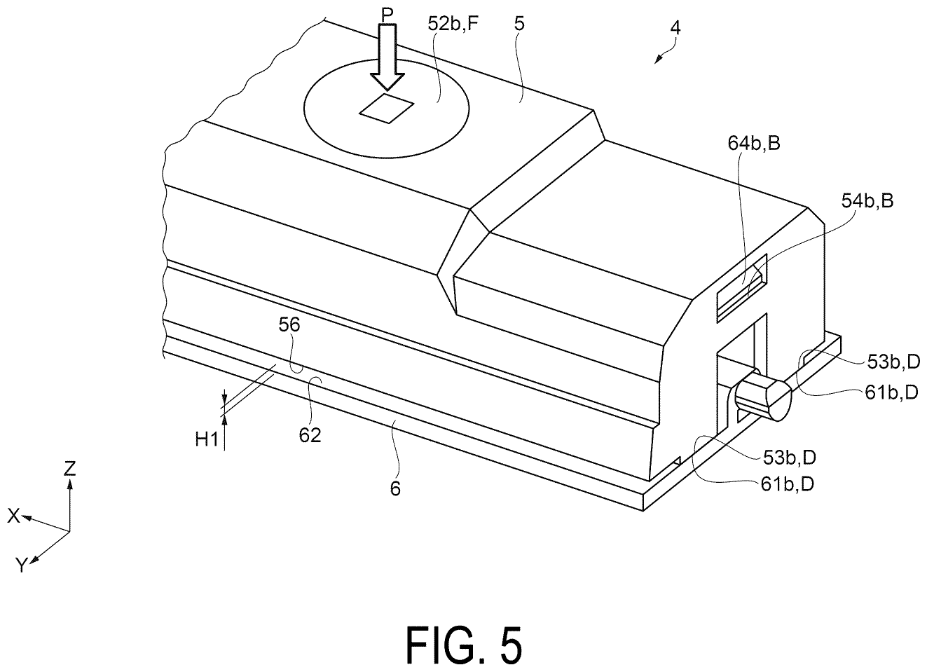

The second position B, the fourth position D, and the sixth position F at the front of the cover 5 and the frame 6 will be described in detail with reference to FIG. 5.

As described above, the pressing force P of the first elastic member 51 is transmitted to the second receiving portion 52b, which is the sixth position F. At the front end of the cover 5, the second engaging claw 64b of the frame 6 is engaged with the second engaging hole 54b of the cover 5 and fixed as a snap-fit to be the second position B.

A position at which the second cover end 53b located below the front end of the cover 5 abuts against the second frame end 61b located above the front end of the frame 6 is referred to as the fourth position D. In the example of FIG. 5, the second cover ends 53b abut against the second frame ends 61b at two positions in the left-right direction. The second position B and the fourth position D are in a vertical positional relationship.

The pressing force P of the first elastic member 51 is sequentially transmitted to the sixth position F that is located slightly closer to the center in the front-rear direction with respect to the front end of the cover 5, to the second position B that is the front ends of the cover 5 and the frame 6, and to the fourth position D located below the second position B.

As illustrated in FIG. 5, the cover 5 has a cover edge 56 extending in the front-rear direction on the lower side, and the frame 6 has a frame edge 62 extending in the front-rear direction on the upper side. The cover edge 56 and the frame edge 62 are in a positional relationship in which they face each other.

The cover edge 56 and the frame edge 62 are separated from each other in the up-down direction by a clearance of a distance H1. The cover edge 56 and the frame edge 62 do not abut against each other. That is, the frame 6 and the cover 5 are separated from each other in the pressing direction of the pressing force P.

As a result, as illustrated in FIG. 6, the cover 5 is supported by the first cover end 53a and the second cover end 53b to be suspended between the first frame end 61a and the second frame end 61b of the frame 6. In other words, the cover 5 is suspended between the third position C and the fourth position D.

That is, the cover 5 and the frame 6 do not abut against each other on the lower side at positions other than the third position C at the rear end and the fourth position D at the front end.

Further, the cover 5 and the frame 6 do not abut against each other on the upper side at positions other than the first position A at the rear end and the second position B at the front end, which are positions at which the cover 5 and the frame 6 are engaged with each other by the snap-fit.

As a result, at the rear end, the pressing force P of the first elastic member 51 is transmitted to the cover 5 and the frame 6 from the upper side to the lower side, namely, from the first position A toward the third position C, and is not transmitted to other positions. Further, at the front end, the pressing force P of the first elastic member 51 is transmitted to the cover 5 and the frame 6 from the upper side to the lower side, namely, from the second position B to the fourth position D, and is not transmitted to other positions.

With such a configuration, the pressing force P of the first elastic member 51 is not applied to portions other than the front and rear ends of the frame 6. Thus, the frame 6 is inhibited from being bent in the front-rear direction, which is the extending direction of the frame 6, by the pressing force P of the first elastic member 51. Similarly, the CISM 40 mounted on the frame 6 is also inhibited from being bent in the front-rear direction by the pressing force P.

Incidentally, the cover 5 may deform due to the pressing force P or due to a temperature change. Also in this case, the force generated due to the deformation of the cover 5 is transmitted to the frame 6 through the same path as that of the pressing force P of the first elastic member 51. Therefore, the frame 6 and the CISM 40 mounted on the frame 6 are also inhibited from being bent in the front-rear direction, by the force generated due to the deformation of the cover 5.

Further, due to the clearance of the distance H1 illustrated in FIG. 5, an amount of the deformation when the cover 5 deforms can be absorbed, and a direct pressing load from the cover 5 to the frame 6 is suppressed. That is, with the clearance of the distance H1, even when the cover 5 deforms, the cover edge 56 and the frame edge 62 do not abut against each other. Therefore, bending of the frame 6 is reduced, and, as will be described later, bending of the lens array 43 of the CISM 40 supported by the frame 6 can also be reduced.

Note that the same description as that for the above-described front ends of the cover 5 and the frame 6 also applies to the first position A, the third position C, the fifth position E, and the like at the rear ends of the cover 5 and the frame 6, and thus a description for the rear ends is omitted.

FIG. 6 illustrates a positional relationship between the first position A, the second position B, the third position C, the fourth position D, and the fifth position E in the front-rear direction, using the rear end of the first sensor unit 4 as a reference. The front-rear direction is also the extending direction of the first sensor unit 4 and of the CISM 40, the cover 5, and the frame 6 included in the first sensor unit 4.

Further, the first position A and the third position C, and the second position B and the fourth position D have the vertical positional relationship as described above, and are thus located at the same position in the front-rear direction.

A distance LA from the first position A and the third position C to the second position B and the fourth position D, respectively, is also the length of the first sensor unit 4 and the length of each of the CISM 40, the cover 5, and the frame 6 included in the first sensor unit 4.

A distance LB, which is half of the distance LA, is also half of those lengths. Further, the position of the distance LB is also the central position between the first position A and the second position B, and is also the central position between the third position C and the fourth position D.

A distance LC from the first position A and the third position C to the fifth position E is shorter than the distance LB.

Note that a positional relationship between the first position A, the second position B, the third position C, the fourth position D, and the fifth position E in the front-rear direction, when using the front end of the first sensor unit 4 as a reference, is also the same as described above.

That is, the distance from the first position A and the third position C to the second position B and the fourth position D, respectively, is the distance LA. The position of the distance LB is also the central position between the first position A and the second position B, and is also the central position between the third position C and the fourth position D. The distance LC from the second position B and the fourth position D to the sixth position F is shorter than the distance LB.

FIG. 7 is a perspective view of a cross-section taken along the line I-I in FIG. 6. As illustrated in FIG. 7, the first sensor unit 4 includes the CISM 40, the cover 5, and the frame 6. The CISM 40 includes the substrate 41 on which a plurality of sensors serving as photoelectric conversion elements are mounted, the LED array 42 including a plurality of LEDs serving as light sources, and the lens array 43 including a plurality of lenses serving as light collectors. Each of these components is formed in an elongated shape and extends in the front-rear direction.

That is, the first sensor unit 4 includes the lens array 43 having the elongated shape, the frame 6 that supports the lens array 43, and the cover 5 that engages with the frame 6 and covers the lens array 43.

The cover glass 65 is provided on the lower side of the frame 6. As described above, an upper portion of the transport path 26 is constituted by the frame 6, and a part thereof is constituted by the cover glass 65 provided at the frame 6.

The medium M transported on the transport path 26 can be read by the first sensor unit 4 from above, through the cover glass 65 provided at the frame 6.

A configuration in which the CISM 40 of the first sensor unit 4 reads an image of the medium M will be described.

The medium M (not illustrated in FIG. 7) transported below the cover glass 65 of the frame 6 is irradiated with light from the LED array 42 of the CISM 40. The light emitted from the LED array 42 is reflected by the medium M via the cover glass 65. The light reflected from the medium M forms an image on the sensor of the substrate 41 via the lens array 43, is converted into an electrical signal, and is acquired as image information.

As described above, the pressing force P of the first elastic member 51 is transmitted to the cover 5 and the frame 6 via the sixth position F, the second position B, and the fourth position D. The pressing force P acts so as to push the first sensor unit 4 fixed to the frame 6 toward the transport path 26 via the cover 5, and as a result, the first sensor unit 4 can be located at a predetermined position.

The first elastic member 51 can set the distance between the first sensor unit 4 and the medium M transported on the transport path 26 to a predetermined distance.

That is, the lens array 43 mounted on the first sensor unit 4 can be located at an appropriate position by the first elastic member 51. In addition, the distance between the lens array 43 mounted on the first sensor unit 4 and the medium M on the transport path 26 can also be set to a predetermined distance. As a result, the medium M can be brought into focus, and the image of the medium M can be correctly formed on the sensor of the substrate 41.

If the position of the lens array 43 of the first sensor unit 4 changes, deviation of a focal point on the medium M may occur, and the image of the medium M may not be correctly formed on the sensor of the substrate 41.

According to the above-described configuration, the pressing force P of the first elastic member 51 is applied only to the front and rear ends of the frame 6. The pressing force P is not directly applied to the CISM 40 attached to the frame 6 and the lens array 43 mounted on the CISM 40. Further, the force generated when the cover 5 deforms due to the pressing force P or the temperature change is also transmitted through the same path as that of the pressing force P of the first elastic member 51.

In this way, the frame 6 is inhibited from being bent in the front-rear direction by the force generated due to the deformation of the cover 5, the pressing force P of the first elastic member 51, or the like. Similarly, bending of the CISM 40 attached to the frame 6 and bending of the lens array 43 mounted on the CISM 40 are also suppressed.

As a result, it is possible to suppress a change in the position of the lens array 43 of the first sensor unit 4, and the lens array 43 can be located at an appropriate position. Further, the lens array 43 can focus on the medium M, and the image of the medium M can be correctly formed on the sensor of the substrate 41.

As illustrated in FIG. 7, the substrate 41 is disposed above the lens array 43 of the CISM 40, and a clearance in the up-down direction, between a cover-facing surface 57 of the cover 5 and a substrate-facing surface 41a of the substrate 41, is a distance H2. In other words, in the up-down direction, with reference to the position of the cover glass 65, the distance from the cover glass 65 to the cover-facing surface 57 is longer than the distance from the cover glass 65 to the substrate-facing surface 41a. In this way, the substrate 41 and the cover 5 do not abut against each other.

Due to the distance H2, the substrate 41 does not directly receive the pressing force P of the first elastic member 51 from the cover 5, and damage to the substrate 41 due to the pressing force P can be suppressed.

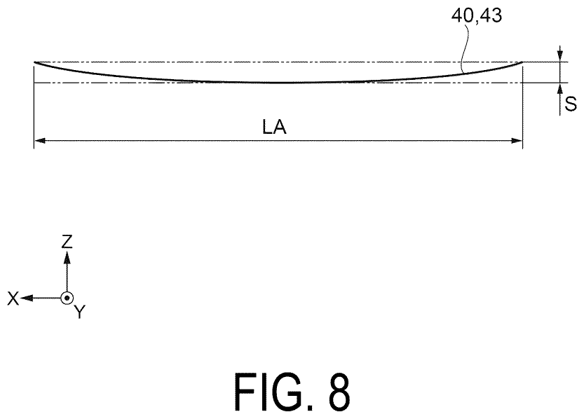

According to the above-described configuration, as illustrated in FIG. 8, even when the force generated due to the deformation of the cover 5 or the pressing force P of the first elastic member 51 is applied, it is possible to keep warping, which is bending, of the lens array 43 with respect to the above-described distance LA that is the length of the lens array 43, within a range of a distance S. Note that the lens array 43 is bent downward into a curved convex shape.

A bending rate, which is a ratio of the bending distance S of the lens array 43 to the distance LA, which is the length of the lens array 43, is calculated by S/LA, which is a value obtained by dividing the bending distance S by the distance LA, which is the length of the lens array 43. The bending rate of the lens array 43 can be set to, for example, 0.1% or less.

Similarly, the bending rate of the CISM 40 can also be suppressed, and can be set to, for example, 0.1% or less.

According to the embodiment described above, the image reading device 2 includes the transport unit 24 that transports the medium M along the transport path 26, the first sensor unit 4 that is disposed on the transport path 26 and reads the image of the transported medium M, and the first elastic member 51 that is the pressing unit that presses the first sensor unit 4 toward the transport path 26 facing the first sensor unit 4.

The first sensor unit 4 includes the lens array 43 having the elongated shape, the frame 6 that is the base frame that supports the lens array 43, and the cover 5 that is the cover portion that engages with the frame 6 and covers the lens array 43.

The first elastic member 51 abuts against the cover 5 and presses the cover 5 toward the transport path 26 from the fifth position E and the sixth position F, which are the abutting portions that abut against the cover 5. In the pressing direction in which the first elastic member 51 presses the cover 5, the frame 6 and the cover 5 are separated by the distance H1.

With the above-described configuration, even when the force generated due to the deformation of the cover 5, the pressing force P of the first elastic member 51, or the like is applied, bending of the frame 6 is suppressed, and bending of the CISM 40 fixed to the frame 6 and bending of the lens array 43 mounted on the CISM 40 are also suppressed. That is, a change in the position of the lens array 43 is suppressed, and thus deviation of the focal point is suppressed. The position of the lens array 43 can be set to an appropriate position.

As a result, in the first sensor unit 4, it is possible to cause the lens array 43 to correctly form the image of the medium M on the sensor of the substrate 41. The image reading device 2 can correctly read the image of the medium M.

A detailed description of the embodiment has been given above with reference to the drawings. However, specific configurations are not limited to the embodiment, and may be modified, replaced, deleted, or the like, provided that they do not depart from the gist of the present disclosure.

For example, the configuration may be the multifunction peripheral 1 to which the above-described image reading device 2 is applied. Further, only one of the first elastic members 51 may be provided so as to press the cover 5 from the position of the distance LB illustrated in FIG. 6, in the front-rear direction.

### 3. Configuration of Lower Unit 121

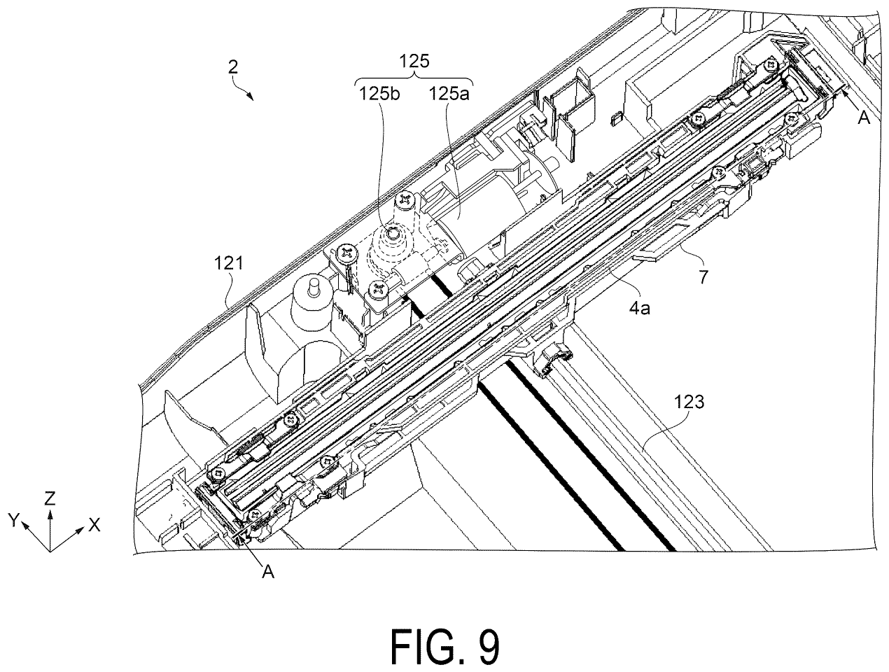

FIG. 9 illustrates a schematic configuration of the lower unit 121. FIG. 9 is a perspective view illustrating the vicinity of an end portion in the +Y direction of the lower unit 121. The second sensor unit 4a, a carriage 7, a rail 123, and the moving unit 125 are disposed in the lower unit 121.

The second sensor unit 4a is disposed along the X-axis. The second sensor unit 4a is mounted on the carriage 7. The second sensor unit 4a faces the document table 27 disposed at a position in the +Z direction.

The carriage 7 movably supports the second sensor unit 4a. The carriage 7 moves along the rail 123 by the driving force of the moving unit 125. The carriage 7 moves along the rail 123, thereby moving the second sensor unit 4a along the rail 123.

The rail 123 is disposed along the Y-axis, which is a movement axis. The rail 123 supports the carriage 7. The carriage 7 moves in the +Y direction or the −Y direction along the Y-axis. When the carriage 7 moves along the Y-axis, the second sensor unit 4a reads the medium M placed on the document table 27.

The moving unit 125 moves the carriage 7. The moving unit 125 is disposed at a position in the end portion in the +Y direction of the lower unit 121. The moving unit 125 includes a moving unit driving source 125a and a moving unit drive transmission mechanism 125b.

The moving unit driving source 125a generates the driving force for moving the carriage 7. The moving unit driving source 125a is constituted by a motor, for example. The moving unit driving source 125a generates a rotational force as the driving force.

The moving unit drive transmission mechanism 125b transmits the driving force generated by the moving unit driving source 125a to the carriage 7. The moving unit drive transmission mechanism 125b is constituted by gears, rollers, and the like. As one example, the moving unit drive transmission mechanism 125b transmits the driving force generated by the moving unit driving source 125a to a belt coupled to the carriage 7. The belt is rotated by the driving force. As the belt rotates, the carriage 7 moves in the +Y direction or the −Y direction along the rail 123.

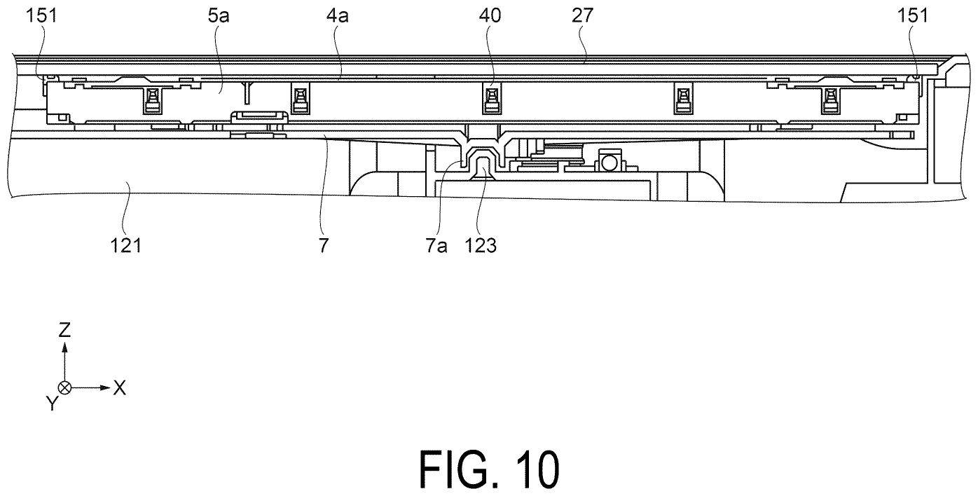

FIG. 10 illustrates a cross-sectional configuration of the lower unit 121. FIG. 10 illustrates a cross section taken along the line A-A in FIG. 9. FIG. 10 illustrates a cross-sectional configuration of a part of the lower unit 121 including the second sensor unit 4a and the carriage 7. FIG. 10 illustrates a cross-sectional configuration including the document table 27.

The second sensor unit 4a includes a second sensor cover 5a and the CISM 40. Here, CISM is an abbreviation for contact image sensor module. A configuration of the CISM 40 will be described later. The second sensor unit 4a, and the CISM 40 and the second sensor cover 5a included in the second sensor unit 4a are each configured to have an elongated shape along the X-axis.

The second sensor cover 5a covers the CISM 40, a second sensor frame 6a described later, and the like. The second sensor cover 5a is supported by the carriage 7 using a support member 150 described later. The second sensor cover 5a corresponds to an example of a cover portion. Sliders 151 are provided at the second sensor cover 5a.

The sliders 151 are caused to contact the surface in the −Z direction of the document table 27, by the pressing force of the support member 150. When the carriage 7 moves along the Y-axis, the sliders 151 slide with respect to the surface in the −Z direction of the document table 27. The sliders 151 are provided at an end portion in the +X direction and an end portion in the −X direction of the second sensor cover 5a. When the sliders 151 contacts the surface in the −Z direction of the document table 27, the distance between the second sensor unit 4a and the medium M is regulated to be a predetermined distance. The sliders 151 may be configured integrally with the second sensor cover 5a, or may be configured as separate members from the second sensor cover 5a.

The carriage 7 includes a carriage engaging portion 7a. The carriage engaging portion 7a engages with the rail 123. When the carriage 7 moves along the Y-axis, the carriage engaging portion 7a slides with respect to the rail 123.

### 4. Configuration of Carriage 7 and Second Sensor Unit 4a

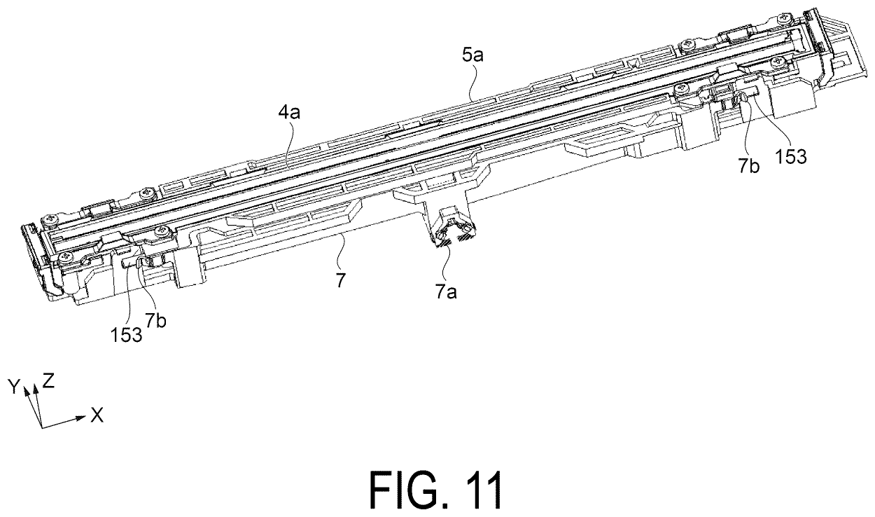

FIG. 11 illustrates a configuration of the second sensor unit 4a and the carriage 7. FIG. 11 is a perspective view illustrating the second sensor unit 4a and the carriage 7. FIG. 11 illustrates engaging protrusions 153 and engaging hooks 7b.

The engaging protrusion 153 is provided at the second sensor cover 5a. The engaging protrusion 153 is provided at the side surface in the −Y direction of the second sensor cover 5a. The engaging protrusion 153 protrudes from the side surface in the −Y direction of the second sensor cover 5a. The second sensor cover 5a includes, for example, the engaging protrusion 153 provided at a position in an end portion in the −X direction of the second sensor cover 5a, and the engaging protrusion 153 provided at a position in an end portion in the +X direction of the second sensor cover 5a. The engaging protrusion 153 provided at the position in the end portion in the −X direction includes a columnar portion protruding in the −X direction along the X-axis intersecting the Y-axis. The engaging protrusion 153 provided at the position in the end portion the +X direction includes a columnar portion protruding in the +X direction along the X-axis intersecting the Y-axis. The engaging protrusion 153 corresponds to an example of an engaged portion. Each of the −X direction and the +X direction corresponds to an example of a direction intersecting a movement axis.

The engaging hook 7b is provided at the side surface in the −Y direction of the carriage 7. The engaging hook 7b is configured to be engageable with the engaging protrusion 153 from the −Z direction. The carriage 7 is provided with the engaging hooks 7b that engage with the two engaging protrusions 153, respectively. The engaging hook 7b is configured to be deformable along the Z-axis. Deformation of the engaging hook 7b allows the engaging protrusion 153 to move along the Z-axis. The engaging hook 7b engages with the engaging protrusion 153 such that deformation of the engaging hook 7b causes the engaging protrusion 153 to be movable in the +Z direction that is a direction approaching the document table 27, and in the −Z direction that is a direction away from the document table 27. When the surface in the −Z direction of the document table 27 has irregularities, the second sensor unit 4a can move along the irregularities.

The second sensor cover 5a includes the engaging protrusion 153 protruding in the +X direction or the −X direction intersecting the Y-axis. The carriage 7 includes the engaging hook 7b that engages with the engaging protrusion 153. The engaging hook 7b corresponds to an example of an engaging portion. The engaging hook 7b engages with the engaging protrusion 153 such that the engaging protrusion 153 can move in the +Z direction that is the direction approaching the document table 27, and in the −Z direction that is the direction away from the document table 27.

When the surface in the −Z direction of the document table 27 has steps, irregularities, or the like, since the engaging hook 7b deforms, the second sensor unit 4a can move along the steps, the irregularities, or the like.

### Configuration of Second Sensor Unit 4a

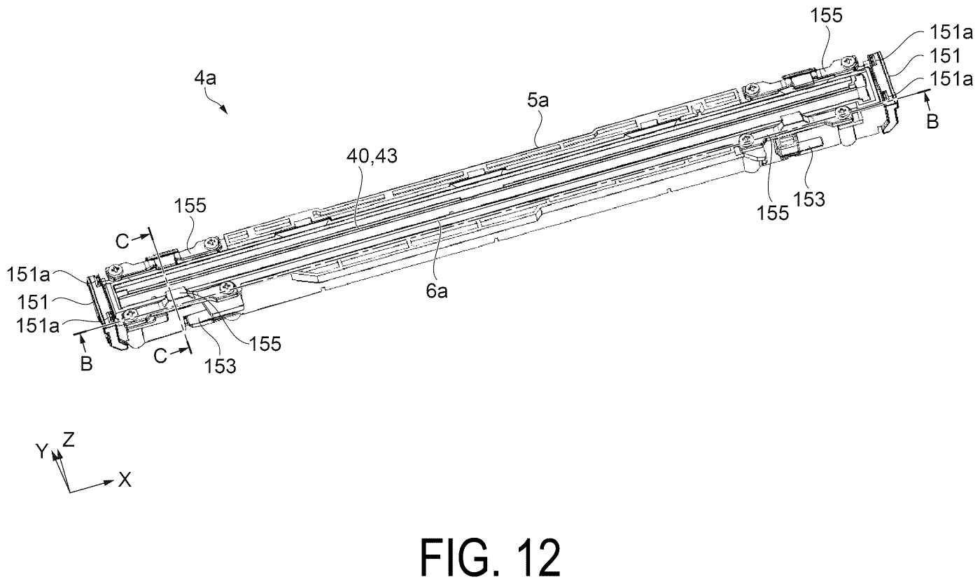

FIG. 12 illustrates a schematic configuration of the second sensor unit 4a. FIG. 12 is a perspective view illustrating the second sensor unit 4a. The second sensor unit 4a includes the second sensor cover 5a, the second sensor frame 6a, and the CISM 40.

The second sensor cover 5a includes the sliders 151, the engaging protrusions 153, and pressing members 155.

The slider 151 includes a slider protrusion 151a that contacts the surface in the −Z direction of the document table 27. The slider 151 illustrated in FIG. 12 includes two of the slider protrusions 151a along the Y-axis. The number of slider protrusions 151a is not limited to two. The number of slider protrusions 151a may be one or more. Since the plurality of slider protrusions 151a are provided along the Y-axis, the inclination of the second sensor unit 4a may be reduced.

The pressing member 155 is attached to a surface in the +Z direction of the second sensor cover 5a. The pressing member 155 regulates movement, toward the document table 27, of the second sensor frame 6a disposed in the second sensor cover 5a. The second sensor frame 6a will be described later. Four of the pressing members 155 are attached to the second sensor cover 5a illustrated in FIG. 12. The pressing members 155 are attached to a position in an end portion in the −X direction of the second sensor cover 5a, and to a position in an end portion in the +X direction of the second sensor cover 5a.

The second sensor frame 6a supports the lens array 43 and the like included in the CISM 40. The configuration of the CISM 40 will be described later. The second sensor frame 6a is covered with the second sensor cover 5a. The second sensor frame 6a corresponds to an example of a base frame.

The CISM 40 includes the lens array 43. The lens array 43 is disposed at a position facing the document table 27. The lens array 43 is supported by the second sensor frame 6a. The lens array 43 is covered with the second sensor cover 5a.

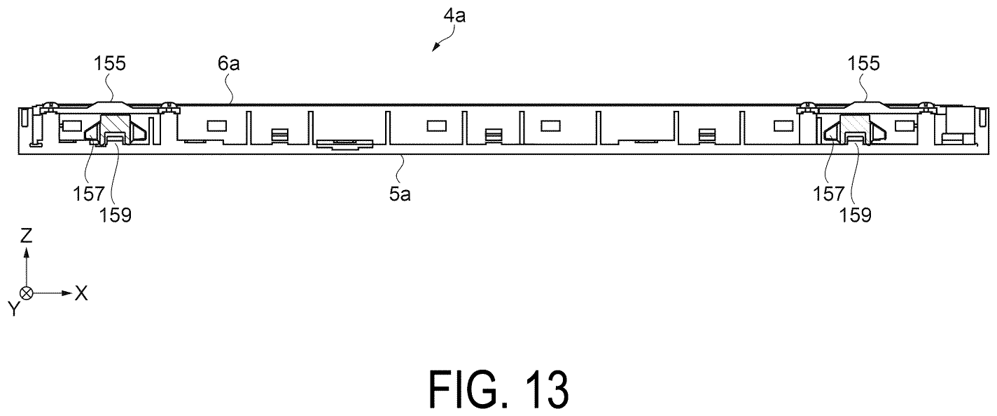

FIG. 13 illustrates a cross-sectional configuration of the second sensor unit 4a. FIG. 13 is a cross-sectional view taken along the line B-B in FIG. 12. FIG. 13 illustrates the second sensor cover 5a, the second sensor frame 6a, the pressing members 155, and positioning members 157, all of which are included in the second sensor unit 4a.

The positioning member 157 regulates the position of the second sensor frame 6a along the Y-axis. The positioning member 157 is disposed at a position in the −Y direction of the second sensor frame 6a. The positioning member 157 is disposed at a position on the −Z direction of the pressing member 155. The second sensor unit 4a illustrated in FIG. 13 illustrates two of the positioning members 157. The two positioning members 157 are disposed at a position in an end portion in the +X direction of the second sensor unit 4a, and at a position in an end portion in the −X direction of the second sensor unit 4a. The number of positioning members 157 is not limited to two. Only one of the positioning members 157 may be provided, or a plurality of the positioning members 157 may be provided.

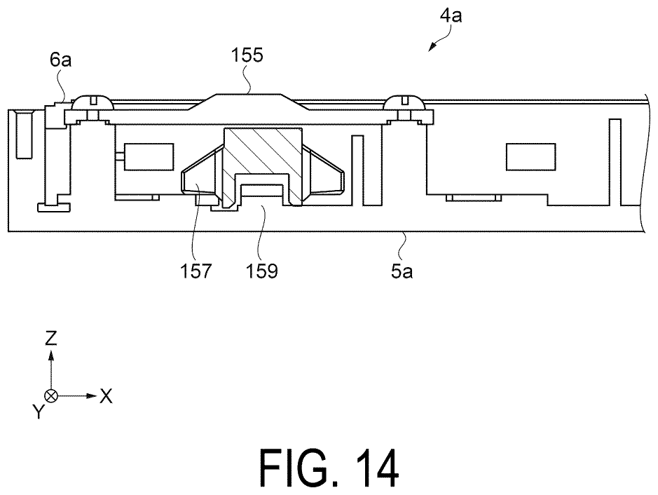

FIG. 14 illustrates a cross-sectional configuration of the second sensor unit 4a. FIG. 14 is an enlarged view of the vicinity of the pressing member 155 taken along the line B-B in FIG. 12. FIG. 14 is an enlarged view of the vicinity of the pressing member 155 disposed at a position in the end portion in the −X direction of the second sensor unit 4a.

The second sensor cover 5a includes a frame support portion 159. The frame support portion 159 is provided on the surface in the −Z direction of the second sensor cover 5a facing the second sensor frame 6a. The frame support portion 159 supports the second sensor frame 6a from below. The frame support portion 159 is disposed below the pressing member 155.

The second sensor frame 6a is supported by the frame support portion 159. The second sensor frame 6a is supported by the second sensor cover 5a at the position of the frame support portion 159.

FIG. 14 illustrates a configuration in the vicinity of the pressing member 155 disposed at the position in the end portion in the −X direction of the second sensor unit 4a. The configuration in the vicinity of the pressing member 155 disposed at the position in the end portion in the +X direction of the second sensor unit 4a is the same as the configuration illustrated in FIG. 14. The frame support portion 159 is disposed below the pressing member 155 disposed at the position in the end portion in the +X direction of the second sensor unit 4a.

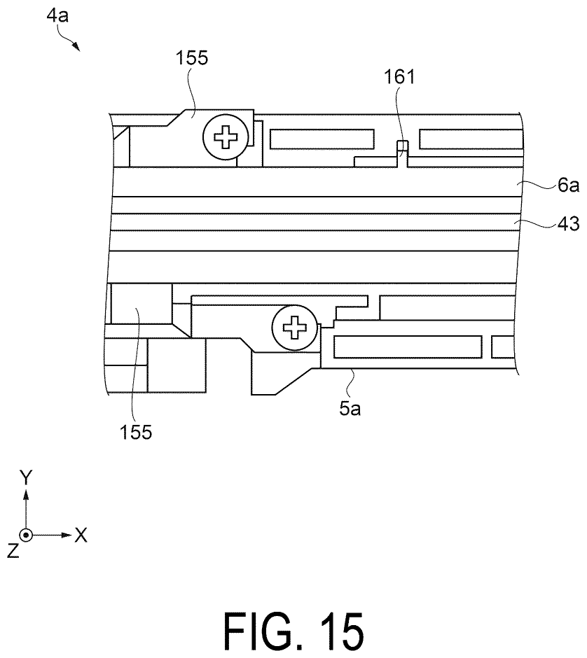

FIG. 15 is an enlarged view of a part of the second sensor unit 4a. FIG. 15 illustrates the vicinity of the pressing member 155 disposed at the position in the end portion in the −X direction of the second sensor unit 4a. FIG. 15 is an enlarged plan view as viewed from the +Z direction.

The second sensor frame 6a includes a protruding portion 161. The protruding portion 161 protrudes in the +Y direction from the side surface in the +Y direction of the second sensor frame 6a. The side surface in the +X direction of the protruding portion 161 and the side surface in the −X direction of the protruding portion 161 are configured to be able to contact the second sensor cover 5a. When the side surface in the +X direction or the side surface in the −X direction of the protruding portion 161 contacts the second sensor cover 5a, the position of the second sensor frame 6a along the X-axis is regulated. The protruding portion 161 regulates the position of the second sensor frame 6a along the X-axis.

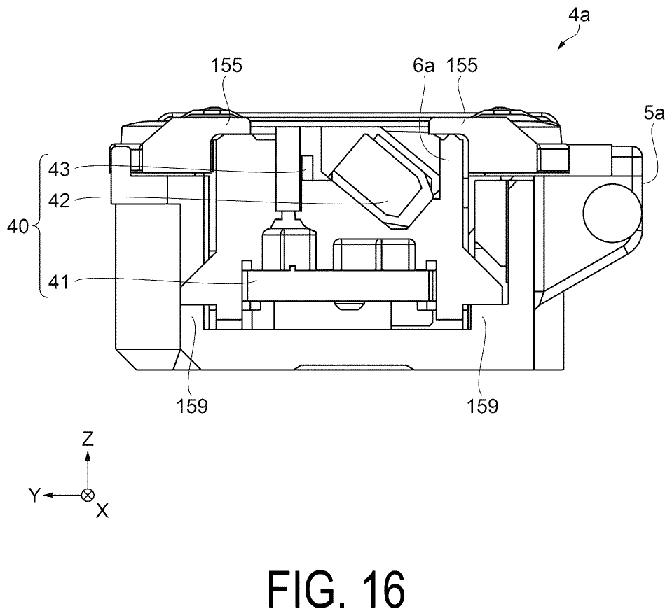

FIG. 16 illustrates a schematic configuration of the second sensor unit 4a. FIG. 16 illustrates a cross section taken along the line C-C in FIG. 12. FIG. 16 illustrates the second sensor cover 5a, the second sensor frame 6a, the CISM 40, and the pressing members 155 included in the second sensor unit 4a.

The frame support portions 159 of the second sensor cover 5a are provided on the side surface in the +Y direction and the side surface in the −Y direction of the second sensor cover 5a. The frame support portion 159 supports the second sensor frame 6a in the X-Y plane.

The CISM 40 converts the image of the medium M into an electrical signal. The first sensor unit 4 and the second sensor unit 4a read the image of the medium M using the electrical signal converted by the CISM 40. The CISM 40 includes the substrate 41, the LED array 42, and the lens array 43.

A plurality of sensors serving as photoelectric conversion elements are mounted on the substrate 41. The plurality of sensors are disposed at the substrate 41 along the X-axis. The substrate 41 receives light via the lens array 43, and converts the received light into an electric signal. The substrate 41 included in the CISM 40 of the second sensor unit 4a is covered with the second sensor cover 5a. The substrate 41 included in the CISM 40 of the second sensor unit 4a is supported by the second sensor frame 6a.

The LED array 42 includes a plurality of LEDs serving as light sources. LED is an abbreviation for light emitting diode. The LED array 42 emits light toward the medium M. The LED array 42 mounted on the second sensor unit 4a emits light toward the medium M placed on the document table 27. The LED array 42 included in the CISM 40 of the second sensor unit 4a is covered with the second sensor cover 5a. The LED array 42 included in the CISM 40 of the second sensor unit 4a is supported by the second sensor frame 6a.

The lens array 43 includes a plurality of lenses serving as light collectors. The lens array 43 is, for example, a rod lens array. The lens array 43 collects the light emitted from the LED array 42 and reflected by the medium M. The light collected by the lens array 43 is received by the substrate 41. The lens array 43 included in the CISM 40 of the second sensor unit 4a is covered with the second sensor cover 5a. The lens array 43 included in the CISM 40 of the second sensor unit 4a is supported by the second sensor frame 6a.

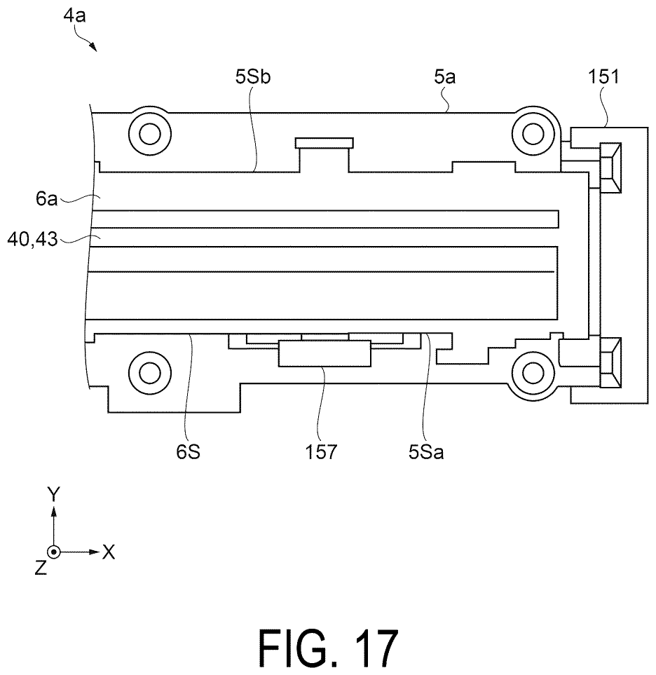

FIG. 17 is an enlarged view of a part of the second sensor unit 4a. FIG. 17 is an enlarged view of the end portion in the +X direction of the second sensor unit 4a. FIG. 17 is a plan view as viewed from the +Z direction. FIG. 17 illustrates a state in which the pressing members 155 are removed. FIG. 17 illustrates the second sensor cover 5a, the second sensor frame 6a, the CISM 40, and the positioning member 157 included in the second sensor unit 4a.

The positioning member 157 is disposed at a first cover side surface 5Sa, which is the inner side surface in the −Y direction of the second sensor cover 5a. The first cover side surface 5Sa is a surface intersecting the Y-axis. The first cover side surface 5Sa illustrated in FIG. 17 is a surface orthogonal to the Y-axis. The positioning member 157 contacts a frame side surface 6S in the −Y direction of the second sensor frame 6a. The frame side surface 6S is a surface intersecting the Y-axis. The frame side surface 6S illustrated in FIG. 17 is a surface orthogonal to the Y-axis. The positioning member 157 presses the second sensor frame 6a toward a second cover side surface 5Sb, which is the inner side surface in the +Y direction of the second sensor cover 5a. The second sensor frame 6a is pressed against the second cover side surface 5Sb. The position of the second sensor frame 6a along the Y-axis is determined by the second cover side surface 5Sb. The positioning member 157 regulates the position of the second sensor frame 6a along the Y-axis. The positioning member 157 regulates the position of the second sensor frame 6a along the Y-axis, thereby stabilizing a reading position of the second sensor unit 4a along the Y-axis.

The positioning member 157 is provided that is disposed at the first cover side surface 5Sa, of the second sensor cover 5a, intersecting the Y-axis, and that brings the frame side surface 6S, of the second sensor frame 6a, intersecting the Y-axis into contact with the second cover side surface 5Sb facing the first cover side surface 5Sa.

The positioning member 157 can stabilize the reading position of the second sensor unit 4a along the Y-axis.

### 5. Support Configuration of Second Sensor Unit 4a

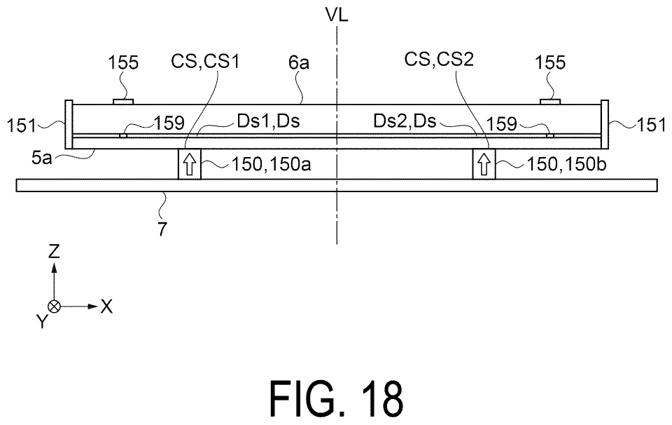

FIG. 18 schematically illustrates a support configuration of the second sensor unit 4a. FIG. 18 illustrates a schematic configuration of the second sensor unit 4a and the carriage 7. FIG. 18 illustrates an X-Z cross section of the second sensor unit 4a and the carriage 7. FIG. 18 illustrates a configuration in which the second sensor unit 4a is supported by the carriage 7.

A first support member 150a, which is one of the support members 150, is provided between the second sensor unit 4a and the carriage 7. The first support member 150a supports the second sensor unit 4a on the carriage 7. The first support member 150a supports the second sensor unit 4a so that the second sensor unit 4a can be pressed in the +Z direction. The first support member 150a presses the second sensor unit 4a toward the document table 27. The first support member 150a is formed of an elastic member such as a spring. The first support member 150a corresponds to an example of a pressing support portion.

The first support member 150a has a first contact surface CS1 that is in contact with the second sensor cover 5a. The first contact surface CS1 is one of contact surfaces CS and corresponds to an example of a contact portion. The first support member 150a is in contact with the second sensor cover 5a at the first contact surface CS1. The first support member 150a presses the second sensor cover 5a in a pressing application direction, which is a direction directly upward from the first contact surface CS1. The pressing force by the first support member 150a is transmitted to the slider 151 of the second sensor cover 5a. Due to the pressing force of the first support member 150a, the slider protrusion 151a of the slider 151 contacts the surface in the −Z direction of the document table 27.

FIG. 18 illustrates a support configuration in which the second sensor unit 4a is supported by two of the support members 150. The two support members 150 are the first support member 150a and a second support member 150b. The first support member 150a has a first contact surface CS1 that is in contact with the second sensor cover 5a. The second support member 150b has a second contact surface CS2 that is in contact with the second sensor cover 5a. The second contact surface CS2 is one of the contact surfaces CS, and corresponds to an example of a second contact portion.

The first support member 150a is in contact with the second sensor cover 5a at the first contact surface CS1. The first support member 150a presses the second sensor cover 5a in a first pressing application direction, which is a direction directly upward from the first contact surface CS1. The pressing force by the first support member 150a is transmitted to the slider 151 of the second sensor cover 5a.

The second support member 150b is in contact with the second sensor cover 5a at the second contact surface CS2. The second support member 150b presses the second sensor cover CS2 in a second pressing application direction, which is a direction directly upward from the second contact surface 5a. The pressing force by the second support member 150b is transmitted to the slider 151 of the second sensor cover 5a. The second support member 150b corresponds to an example of a second pressing support portion.

The first support member 150a is disposed at a position in the −X direction with respect to a virtual vertical line VL passing through the center of the second sensor unit 4a along the X-axis. The second support member 150b is disposed at a position in the +X direction with respect to the virtual vertical line VL. The distance between the position at which the first support member 150a is disposed and the virtual vertical line VL along the X-axis is equal to or substantially equal to the distance between the position at which the second support member 150b is disposed and the virtual vertical line VL.

The first support member 150a is disposed closer to the virtual vertical line VL than the frame support portion 159 provided at the position in the end portion in the −X direction of the second sensor cover 5a. The second support member 150b is disposed closer to the virtual vertical line VL than the frame support portion 159 provided at the position in the end portion in the +X direction of the second sensor cover 5a. The first support member 150a and the second support member 150b are disposed on the inner side along the X-axis, with respect to the two frame support portions 159, respectively.

The two frame support portions 159 are disposed on the outer side of the two support members 150, respectively. The second sensor frame 6a is supported by the frame support portions 159. The lower surface of the second sensor frame 6a is disposed to be separated from the second sensor cover 5a except for the positions at which the second sensor frame 6a is in contact with the frame support portions 159. The second sensor frame 6a is disposed to be separated from the second sensor cover 5a by a separation distance Ds, at a position in a direction directly upward from the contact surface CS of the support member 150. The second sensor frame 6a and the second sensor cover 5a are separated from each other in the direction directly upward from the contact surface CS of the support member 150. Since the second sensor frame 6a and the second sensor cover 5a are separated from each other in the direction directly upward from the contact surface CS of the support member 150, it is possible to inhibit the pressing force of the support member 150 from being directly applied to the second sensor frame 6a. In this way, deformation of the second sensor frame 6a due to the pressing force of the support member 150 is suppressed.

The second sensor frame 6a is disposed at a position in the direction directly upward from the first contact surface CS1 of the first support member 150a, so as to be separated from the second sensor cover 5a by a first separation distance Ds1. The second sensor frame 6a and the second sensor cover 5a are separated from each other in the direction directly upward from the first contact surface CS1 of the first support member 150a.

The second sensor frame 6a is disposed at a position in the direction directly upward from the second contact surface CS2 of the second support member 150b, so as to be separated from the second sensor cover 5a by a second separation distance Ds2. The second separation distance Ds2 is equal or substantially equal to the first separation distance Ds1. The second sensor frame 6a and the second sensor cover 5a are separated from each other in the direction directly upward from the second contact surface CS2 of the second support member 150b.

The number of supporting members 150 may be one or more. The number of support members 150 is preferably two, for example. Since the first support member 150a and the second support member 150b are provided as the two support members 150, bending of the second sensor cover 5a due to its own weight is suppressed. When only one of the support members 150 is provided, the support member 150 is preferably disposed on the virtual vertical line VL.

It is preferable that the image reading device 2 includes the second support member 150b that is in contact with the second sensor cover 5a at a position different from that of the first support member 150a, and that presses the second sensor cover 5a in the second pressing application direction toward the document table 27 from the second contact surface CS2 that is in contact with the second sensor cover 5a. In the second pressing application direction, the second sensor frame 6a and the second sensor cover 5a are separated from each other. By providing the first support member 150a and the second support member 150b, bending of the second sensor cover 5a due to its own weight is suppressed.

The pressing member 155 is disposed at a position in the +Z direction of the frame support portion 159. The frame support portion 159 transmits the pressing force applied from the support member 150 to the second sensor frame 6a. Due to the pressing force transmitted from the frame support portion 159, the second sensor frame 6a moves or deforms toward the document table 27 in the +Z direction. The pressing member 155 can suppress movement or deformation of the second sensor frame 6a toward the document table 27, which are caused by the pressing force of the support member 150.

It is preferable that the image reading device 2 includes the pressing member 155 that is supported by the second sensor cover 5a and that regulates the movement of the second sensor frame 6a toward the document table 27.

The pressing member 155 can suppress movement or deformation of the second sensor frame 6a toward the document table 27, which are caused by the pressing force of the support member 150.

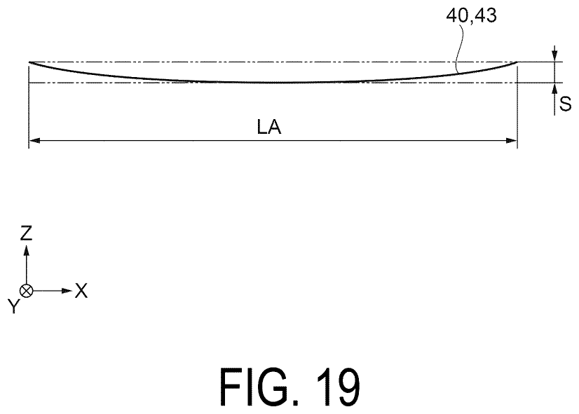

FIG. 19 is a cross section viewed from the −Y direction in which bending of the CISM 40 and the lens array 43 is illustrated. FIG. 19 schematically illustrates bending of the lens array 43 and the like, which is caused by the pressing force of the support member 150.

When the second sensor cover 5a deforms, or when the pressing force of the support member 150 is applied to the second sensor frame 6a, the lens array 43 warps by the bending distance S with respect to the distance LA, which is the length of the lens array 43 along the X-axis. The warpage of the lens array 43 is formed in a shape that is convexly curved toward the −Z direction.

A warpage ratio Wr of the lens array 43, which is the ratio of the bending distance S to the distance LA, is a value obtained by dividing the bending distance S by the distance LA. The warpage ratio Wr is expressed by Equation (1) below.

Wr=S/LA (1)

Since the second sensor frame 6a and the second sensor cover 5a are separated from each other in the direction directly upward from the contact surface CS of the support member 150, the pressing force of the support member 150 is inhibited from being directly applied to the second sensor frame 6a. Since the second sensor frame 6a and the second sensor cover 5a are separated from each other in the direction directly upward from the contact surface CS of the support member 150, the warpage ratio Wr is suppressed to be within a predetermined range. By providing the pressing member 155, the warpage ratio Wr is suppressed to be 0.1% or less, for example.

The pressing member 155 can suppress movement or deformation of the second sensor frame 6a in the +Z direction, which is caused by the pressing force of the support member 150. By providing the pressing member 155, the bending distance S of the lens array 43 is further reduced. The warpage ratio Wr of the lens array 43 is suppressed to be within a further smaller range.

The image reading device 2 includes the document table 27 that is light-transmissive and on which the medium M can be placed, the second sensor unit 4a that reads, through the document table 27, the image of the medium M placed on the document table 27, the carriage 7 that supports the second sensor unit 4a to be movable along the Y-axis, the rail 123 that is disposed along the Y-axis and supports the carriage 7, and the support member 150 that is disposed between the second sensor unit 4a and the carriage 7 and presses the second sensor unit 4a toward the document table 27. The second sensor unit 4a includes the lens array 43 having the elongated shape, the second sensor frame 6a that supports the lens array 43, and the second sensor cover 6a that covers the second sensor frame 5a. The support member 150 is in contact with the second sensor cover 5a and presses the second sensor cover 5a in the pressing application direction from the contact surface CS that is in contact with the second sensor cover 5a, toward the document table 27. In the pressing application direction, the second sensor frame 6a and the second sensor cover 5a are separated from each other.

Since the second sensor frame 6a and the second sensor cover 5a are separated from each other in the direction directly upward from the contact surface CS of the support member 150, the warpage of the lens array 43 is suppressed. The second sensor unit 4a can maintain the reading accuracy.

The warpage ratio Wr of the lens array 43 is preferably 0.1% or less.

Since the warpage ratio Wr of the lens array 43 is 0.1%, the reading accuracy of the second sensor unit 4a is maintained.

### 6. Configuration of Pressing Member 155

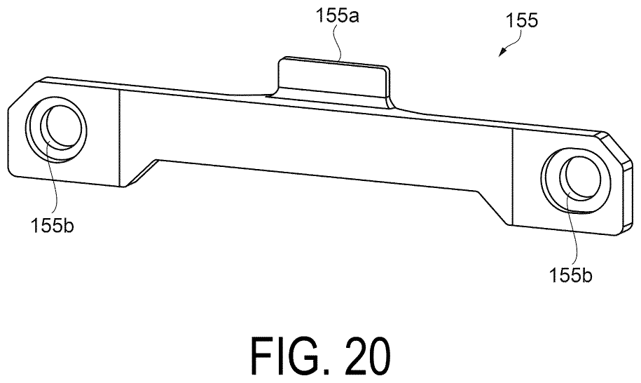

FIG. 20 illustrates a schematic configuration of the pressing member 155. FIG. 20 is a perspective view of the pressing member 155. The pressing member 155 includes a pressing portion 155a and two screw holes 155b.

The pressing portion 155a regulates movement and deformation of the second sensor frame 6a. The pressing portion 155a contacts the surface in the +Z direction of the second sensor frame 6a. The pressing portion 155a contacts the surface in the +Z direction of the second sensor frame 6a to suppress movement and deformation of the second sensor frame 6a toward the document table 27.

A screw is attached to the screw hole 155b. By attaching the screw to the screw hole 155b, the pressing member 155 is attached to the surface in the +Z direction of the second sensor cover 5a.

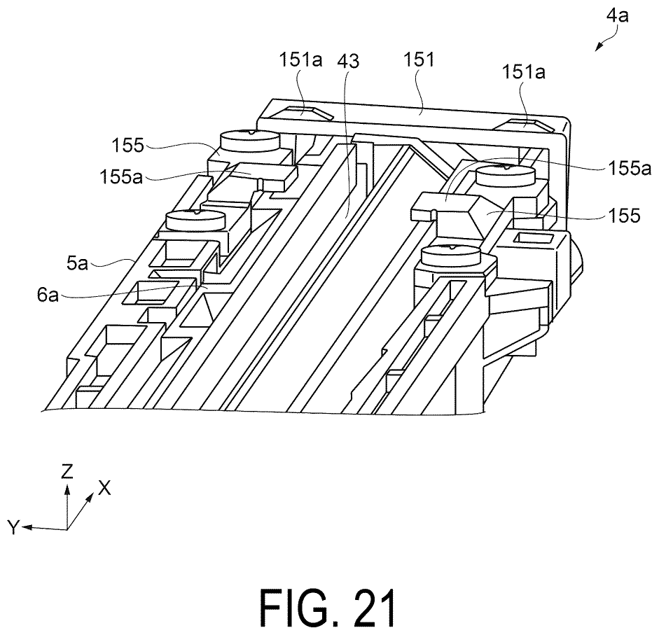

FIG. 21 is an enlarged view of a part of the second sensor unit 4a. FIG. 21 is a perspective view illustrating the end portion in the +X direction of the second sensor unit 4a. FIG. 21 illustrates a state in which the pressing members 155 are attached.

The pressing members 155 are attached to the second sensor cover 5a by screws. When the pressing member 155 is attached to the second sensor cover 5a, the pressing portion 155a protrudes to a position in the +Z direction of the second sensor frame 6a. The pressing portion 155a is disposed at a position in the +Z direction of the second sensor frame 6a. The pressing portion 155a contacts the second sensor frame 6a and regulates movement and deformation of the second sensor frame 6a in the +Z direction. When the pressing portion 155a contacts the second sensor frame 6a, the pressing member 155 can suppress movement and deformation of the second sensor frame 6a toward the document table 27.

### 7. Configuration of Positioning Member 157

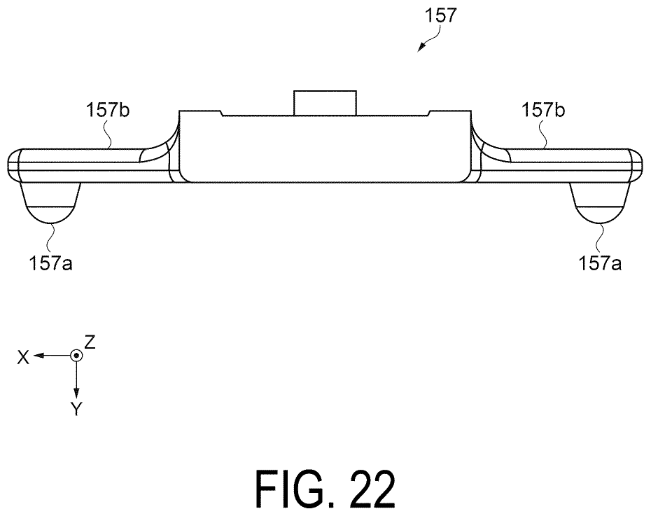

FIG. 22 illustrates a schematic configuration of the positioning member 157. FIG. 22 illustrates a plan view viewed from the +Z direction when the positioning member 157 is attached to the second sensor cover 5a. The positioning member 157 includes frame contact portions 157a and elastic support portions 157b. The positioning member 87 is made of a resin. Since the positioning member 157 is made of a resin, the influence of static electricity on the substrate 41 can be reduced.

The frame contact portion 157a is in contact with the frame side surface 6S of the second sensor frame 6a. The frame contact portion 157a presses the frame side surface 6S toward the second cover side surface 5Sb provided in the +Y direction.

The elastic support portion 157b presses the frame contact portion 157a against the frame side surface 6S. The elastic support portion 157b is configured to be elastically deformable. Using the elasticity of the elastic support portion 157b, the frame contact portion 157a presses the frame side surface 6S.

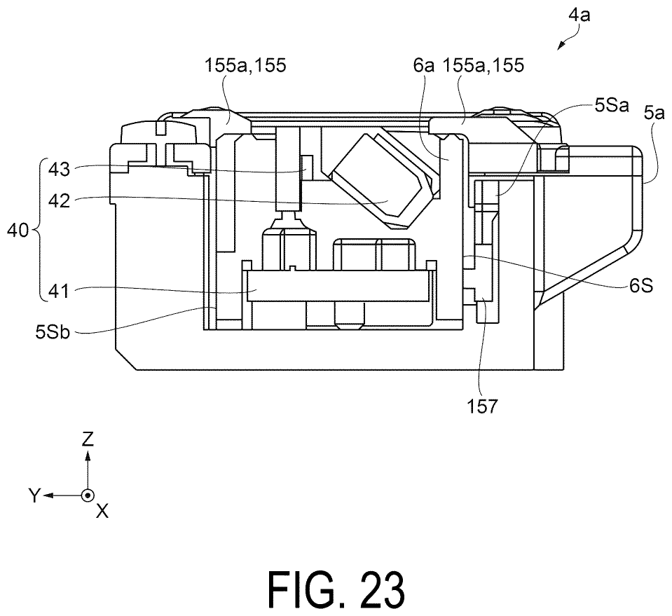

FIG. 23 illustrates a cross-sectional configuration of the second sensor unit 4a. FIG. 23 illustrates a cross-sectional configuration of a position at which the frame contact portion 157a is in contact with the frame side surface 6S. The positioning member 157 presses the frame side surface 6S so as to position the second sensor frame 6a with respect to the second cover side surface 5Sb.

It is preferable that the positioning member 157 is provided at the first cover side surface 5Sa and pressed against the second cover side surface 5Sb. Since the positioning member 157 is provided only at the first cover side surface 5Sa, it is possible to suppress an increase in the width along the Y-axis of the second sensor unit 4a.

What is claimed is:

1. An image reading device comprising:
a transport unit configured to transport a medium along a transport path;
a sensor unit disposed on the transport path and configured to read an image of the transported medium; and
a pressing unit configured to press the sensor unit toward the transport path facing the sensor unit, wherein
the sensor unit includes
a lens array having an elongated shape,
a base frame configured to support the lens array, and
a cover portion configured to engage with the base frame and cover the lens array,
the pressing unit abuts against the cover portion and presses the cover portion toward the transport path from an abutting portion of the pressing unit abutting the cover portion, and
the base frame and the cover portion are separated from each other in a pressing direction in which the pressing unit presses the cover portion.

2. The image reading device according to claim 1, wherein
a substrate is disposed above the lens array, and
a clearance is provided between the substrate and the cover portion.

3. The image reading device according to claim 1, wherein
the base frame and the cover portion are engaged with each other by snap-fit.

4. The image reading device according to claim 3, wherein
a location of the snap-fit engagement is on an upper side of an end of the cover portion.

5. The image reading device according to claim 1, wherein
a warpage ratio with respect to a length of the lens array is 0.1% or less.

6. An image reading device comprising:
a placement unit being light-transmissive and on which a medium is placeable;
a reading unit configured to read, through the placement unit, an image of the medium placed at the placement unit;
a carriage configured to support the reading unit to be movable along a movement axis;
a rail disposed along the movement axis and configured to support the carriage; and
a pressing support portion disposed between the reading unit and the carriage and configured to press the reading unit toward the placement portion, wherein
the reading unit includes
a lens array having an elongated shape,
a base frame configured to support the lens array, and
a cover portion configured to cover the base frame,
the pressing support portion is in contact with the cover portion and presses the cover portion in a pressing application direction toward the placement unit from a contact portion of the pressing support portion in contact with the cover portion and
the base frame and the cover portion are separated from each other in the pressing application direction.

7. The image reading device according to claim 6, comprising
a second pressing support portion being in contact with the cover portion at a position different from that of the pressing support portion, and configured to press the cover portion in a second pressing application direction toward the placement unit from a second contact portion of the second pressing support portion in contact with the cover portion, wherein
the base frame and the cover portion are separated from each other in the second pressing application direction.

8. The image reading device according to claim 6, comprising
a pressing member supported by the cover portion and configured to regulate movement of the base frame toward the placement unit.

9. The image reading device according to claim 6, comprising
a positioning member disposed at a first cover side surface, of the cover portion, intersecting the movement axis, and configured to bring a frame side surface, of the base frame, intersecting the movement axis into contact with a second cover side surface facing the first cover side surface.

10. The image reading device according to claim 6, wherein
the cover portion includes an engaged portion protruding in a direction intersecting the movement axis,
the carriage includes an engaging portion configured to engage with the engaged portion, and
the engaging portion engages with the engaged portion in a manner in which the engaged portion is movable in a direction approaching the placement unit and a direction away from the placement unit.

11. The image reading device according to claim 6, wherein
a warpage ratio of the lens array is 0.1% or less.
